(19) United States
(12) Patent Application Publication
(10) Pub. No.: US 2025/0104318 A1
(43) Pub. Date: Mar. 27, 2025

(54) Real-Time Avatar Animation

(71) Applicant: Samsung Electronics Co., Ltd., Suwon-si (KR)

(72) Inventors: Liang Zhao, Saratoga, CA (US); Siva Penke, San Jose, CA (US); Christopher Peri, Mountain View, CA (US); Byeonghee Yu, Berkeley, CA (US); Jisun Park, Palo Alto, CA (US)

(21) Appl. No.: 18/601,097

(22) Filed: Mar. 11, 2024

Related U.S. Application Data
(60) Provisional application No. 63/540,584, filed on Sep. 26, 2023.

(51) Int. Cl. G06T 13/20; G06T 13/40; G10L 15/02; G10L 15/06; G10L 21/028; G10L 25/63

(52) U.S. Cl. CPC G06T 13/205; G06T 13/40; G10L 15/02; G10L 15/063; G10L 21/028; G10L 25/63; G10L 2015/0635

(57) ABSTRACT

In one embodiment, a method includes accessing an audio input that includes a mixture of vocal sounds and non-vocal sounds and separating, by a trained audio source separation model, the audio input into a first audio output representing the vocal sounds and a second audio output representing the non-vocal sounds. The method further includes determining, by one or more trained avatar animation models and by separately encoding the first audio output representing the vocal sounds and the second audio output representing the non-vocal sounds, an avatar animation temporally corresponding to the audio input; and rendering, in real time and temporally coincident with the audio input, the determined avatar animation.

### PRIORITY CLAIM

This application claims the benefit under 35 U.S.C. § 119 of U.S. Provisional Patent Application No. 63/540,584 filed Sep. 26, 2023, the entirety of which is incorporated by reference herein.

### TECHNICAL FIELD

This application generally relates to real-time avatar animation.

### BACKGROUND

In computing, an avatar is a graphical representation of a person. Avatars often appear with human-like representations but may take animal representations as well. In some circumstances avatars have a customizable appearance. An avatar can take a two-dimensional (2D) form, such as in a profile picture. An avatar can also take a three-dimensional (3D) form. Avatars can be static or can be dynamic, and 3D avatars are often dynamic in that they can be animated so as to move, talk, change facial expressions, and represent a variety of other actions, emotions, or poses.

Karaoke is a popular, interactive entertainment in which people sing along to recorded music. Karaoke is commonly a group activity and may be performed at locations such as Karaoke bars.

### BRIEF DESCRIPTION OF THE DRAWINGS

FIG. 1 illustrates an example method for animating an avatar in accordance with an audio input currently being played.

FIG. 2 illustrates an example deep-neural-network (DNN) architecture for performing the steps of the example method of FIG. 1, among other things.

FIG. 3 illustrates an example DNN architecture for training a source separation model for avatar animation.

FIG. 4 illustrates an example DNN architecture of an instruction classification model.

FIG. 5 illustrates an example DNN architecture of a facial expression model.

FIG. 6 illustrates an example DNN architecture of a dance model.

FIG. 7 illustrates an example computing system.

### DESCRIPTION OF EXAMPLE EMBODIMENTS

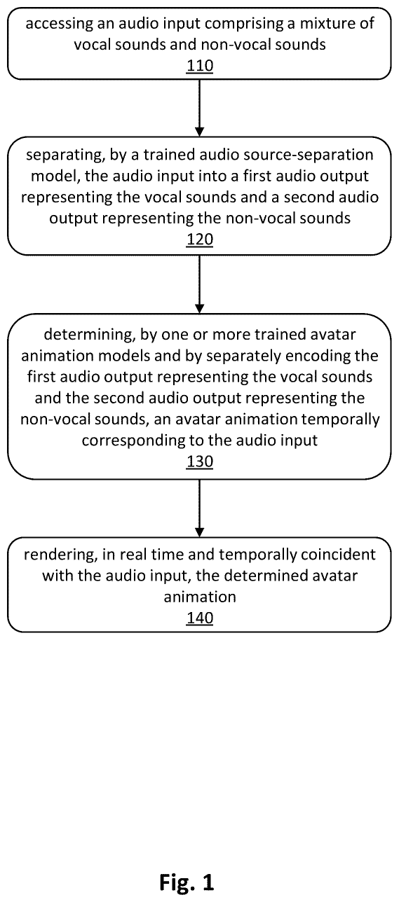

FIG. 1 illustrates an example method for animating an avatar in accordance with an audio input currently being played by client device of a user. Step 110 of the example method of FIG. 1 includes accessing an audio input that includes a mixture of vocal sounds and non-vocal sounds. For example, the audio input may be a song, and the avatar may then sing and/or move (e.g., dance) along to the song. The song may be part of a Karaoke activity, in that one or more users may be using the song to sing along to during a Karaoke performance. In other use cases, the song may be a song that a user is listening to. The avatar may be a two-dimensional avatar or a three-dimensional avatar, and may be displayed on any suitable electronic display (e.g., a display of a television, a monitor, a smartphone, a projector, a wearable device, etc.). While the example audio input in FIG. 1 includes a mixture of both vocal sounds (e.g., speaking or singing) and non-vocal sounds (e.g., music sounds made by instruments, natural sounds, etc.), the deep-neural-network (DNN) architectures and techniques described in this disclosure may also be applied to audio input that contains only one of those two types of sounds. Moreover, an audio input that generally includes both vocal and non-vocal sounds may contain one or more audio portions that include only one of those types of input.

In the example method of FIG. 1, accessing an audio input may include capturing audio, e.g., by a microphone. In particular embodiments, accessing an audio input may include accessing an electronic representation of the audio, e.g., in any of the many types of electronic formats used to represent sound information. In particular embodiments, one or more than one computing device may perform the steps of the example method of FIG. 1. In particular embodiments, a computing device that performs at least some of the steps of the example method of FIG. 1 may generate the audio input (e.g., play a song), may detect the audio input (e.g., using a microphone), or both. In particular embodiments, a computing device that performs at least some the steps of the example method of FIG. 1 may perform neither of those functions (e.g., a set of powered speakers may generate the audio, which may be captured by a microphone of, e.g., a user's smartphone, and an electronic representation of the audio may be accessed in step 110 of the example method of FIG. 1 by a computing device that performs step 110).

As explained below, the audio input accessed in step 110 of the example method of FIG. 1 corresponds to audio currently playing, so that the avatar animation is coincident with the audio being played (e.g., the avatar sings and dances along with the music as it is played).

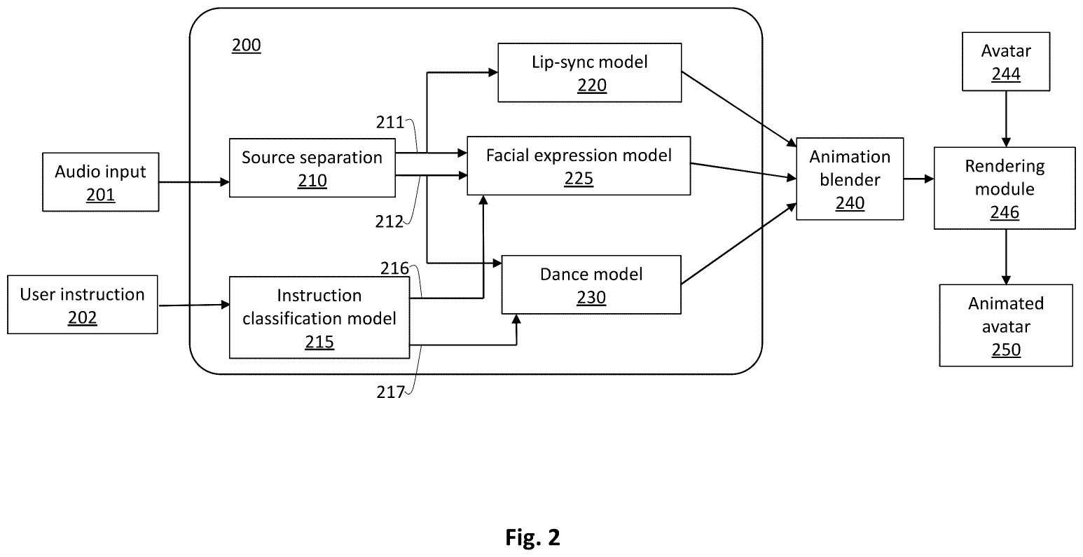

Step 120 of the example method of FIG. 1 includes separating, by a trained audio source-separation model, the audio input into a first audio output representing the vocal sounds and a second audio output representing the non-vocal sounds. FIG. 2 illustrates an example deep-neural-network (DNN) architecture 200 for performing the steps of the example method of FIG. 1, among other things. The example DNN architecture of FIG. 2 illustrates audio input 201 provided to a trained audio source separation model 210. Source separation model 210 separates audio input 201 into vocal output 211 and non-vocal (e.g., music) output 212.

In particular embodiments, the backbone of source separation model is a wave-u-net, which is a multi-scale deep neural network for end-to-end source separation. This backbone DNN architecture includes a set of downsampling blocks for extracting audio features at coarser scales, and a set of upsampling blocks for extracting higher-resolution features. Both features are combined for the final prediction (i.e. output) of vocal sounds and non-vocal sounds, which are output as separate raw audio streams by the source separation model. However, in the DNN architecture of FIG. 2, this backbone is specifically trained for audio source separation in the context of avatar animation, as described below.

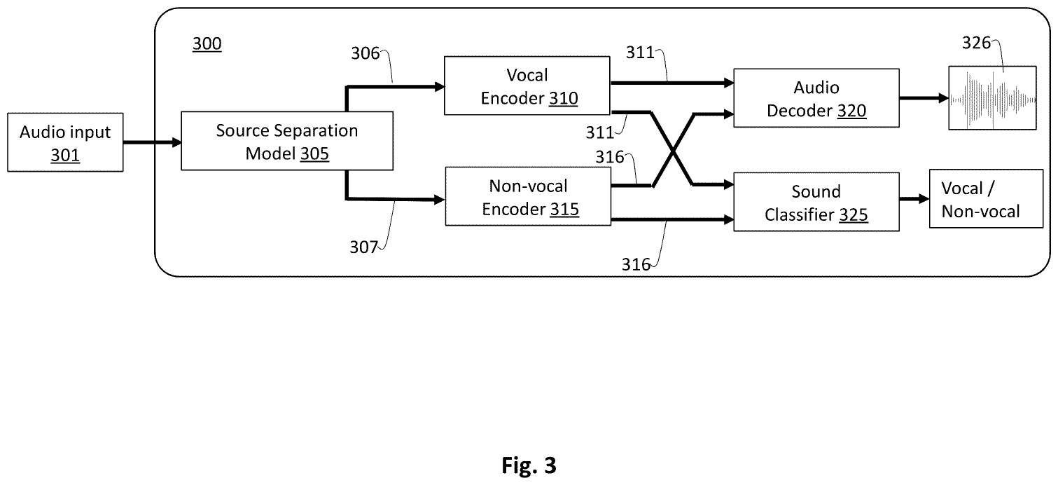

First, training the source-separation model may include additional self-supervised (which is a type of unsupervised) architectural components. These components are not present in the inferencing (run-time) DNN architecture, but their presence during training helps improve the inferencing performance of the source separation model. FIG. 3 illustrates an example DNN training architecture 300 for training a source separation model for the avatar animation described herein. A number of audio inputs 301 are input to untrained source separation model 305. For each audio input 301, source separation model 305 separates audio input 301 into vocal output 306 and non-vocal output 307. Vocal output 306 is provided to vocal encoder 310, which generates vocal features (e.g., one or more feature vectors) 311 based on the vocal output. Non-vocal output 307 is provided to non-vocal encoder 315, which generates non-vocal features (e.g., one or more feature vectors) 316 based on the non-vocal output. Vocal features 311 and non-vocal features 316 are each separately input to audio decoder 320 and audio classifier 325. In one self-supervised learning task, audio decoder 320 takes the input vocal and non-vocal features and outputs a reconstructed composite audio 321. Untrained source-separation model 305 is then refined or updated (e.g., by updating model weights) based on how similar reconstructed composite audio 321 is to input audio 301. In a second self-supervised learning task, sound classifier 325 classifies each input (i.e. each vocal input and each non-vocal input) as a vocal sound or a non-vocal sound. Untrained source-separation model 305 is then refined or updated (e.g., by updating model weights) based on how accurately sound classifier 325 classifies its input.

DNN architecture 300 improves the performance of a trained source separation model, for example because the source separation model 305 separates vocal and non-vocal sounds in its output (e.g., as judged by sound classifier) but is also retaining the meaningful features in mixed audio input 301 to sufficiently reconstruct that audio stream (e.g., for audio decoder 320 to sufficiently reconstruct that stream from the encoded separate outputs made by source separation model 305). As described above, once source separation model 305 is sufficiently trained, then only the trained source separation model of DNN architecture 300 is used during inferencing.

Second, in addition or alternatively to the training procedure described above, a source separation model may be trained in connection with the full DNN architecture pipeline for animating an avatar (e.g., trained along with the other components of DNN architecture 200). The overall training process may be a supervised training process, in that an input audio and a resulting avatar animation are provided to the untrained DNN architecture. The overall DNN architecture (including the source separation model) is updated based on how well the DNN architecture performs in reproducing the provided training animation accompanying an audio input. Therefore, in particular embodiments, during training an untrained source separation model is updated based on both self-supervised tasks specific to the source-separation model, as described above, and based on an overall supervised training process for the entire DNN architecture. As a result, the trained source-separation model used during inferencing can achieve substantially better task-specific (i.e., avatar animation) performance than a model conventionally trained to separate audio into vocal and non-vocal inputs.

In particular embodiments, such as is illustrated in the example DNN architecture of FIG. 2, a method for animating an avatar in accordance with an audio input currently being played may include animating the avatar based on a user instruction. The user instruction may be a natural-language input, such as a spoken input or a written input, related to animation of the avatar. For example, a user instruction may implicate one or more emotions (e.g., happy, sad, excited, confident, passionate, etc.) for animating the avatar, such as a facial expression of the avatar. As another example, a user instruction may implicate a dance style and/or a music style (e.g., jazz, hip-hop, rock, etc.) for animating the avatar.

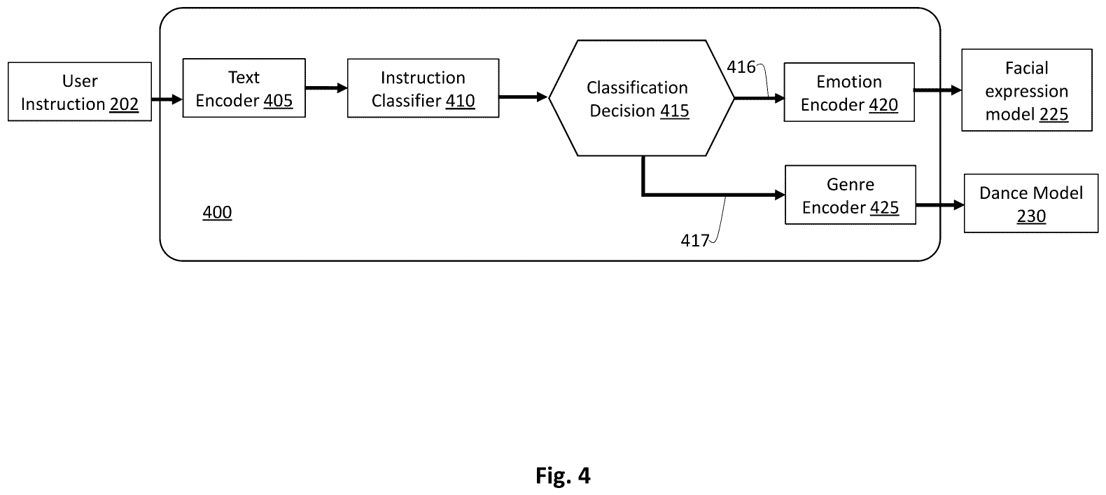

In the example DNN architecture of FIG. 2, a user instruction 202 is provided to an instruction classification model 215, which outputs at least one of an emotion encoding 216 or a dance style (e.g., music genre) encoding 217. FIG. 4 illustrates an example DNN architecture 400 of instruction classification model 215. DNN architecture 400 includes text encoder 405, which encodes user instruction 202 (e.g. into one or more feature vectors) and provides the encoded output to trained instruction classifier 410. Instruction classifier 410 is trained, using supervised training, specifically for the avatar animation tasks described herein. Trained instruction classifier 410 takes the encoded output from text encoder 405 and makes a classification decision 415 by classifying the instruction as emotion-related 416 or as dance-related 417. In particular embodiments, a user instruction may be classified as both or neither emotion-related or dance-related, and this disclosure contemplates that portions of a user instruction may be classified as well (e.g., a portion of a user instruction may be classified as emotion-related, while another portion of the user instruction may be classified as dance related). In the example of FIG. 4, when user instruction 202 is classified as emotion related 416, then the user instruction (or corresponding portion thereof) is sent to emotion encoder 420, which encodes the user instruction (or portion thereof), e.g., as one or more feature vectors, and provides the output to facial expression model 225. When user instruction 202 is classified as dance related 417, then the user instruction (or corresponding portion thereof) is sent to genre encoder 425, which encodes the user instruction (or portion thereof), e.g., as one or more feature vectors, and provides the output to dance model 230.

Step 130 of the example method of FIG. 1 includes determining, by one or more trained avatar animation models and by separately encoding the first audio output representing the vocal sounds and the second audio output representing the non-vocal sounds, an avatar animation temporally corresponding to the audio input. The example DNN architecture of FIG. 2 illustrates an embodiment that uses three trained avatar animation models: lip-sync model 220, facial expression model 225, and dance model 230, although this disclosure contemplates that more than these three or fewer than these three specific animation models may be used. As described more fully herein, in particular embodiments an avatar animation depends not only on the output of a source separation model, but also on the output of an instruction classification model, so that user input can be taken into account when animating an avatar.

Lip-sync model 220 takes as input vocal output 211 from source separation model 210 and generates a sequence of timed visemes for animating a mouth of an avatar, and lip-sync model 220 may be any suitable model for performing those functions. These animation parameters are output by lip-sync model 220 to animation blender 240, which blends this output with any other animation parameters and sends the blended animations to 2D/3D rendering module 246. Rendering module 246 applies the blended animation to a loaded avatar 244, resulting in an animated avatar 250 being displayed on a display, which may be a display that is part of a computing device that performs some or all of the steps of the example method of FIG. 1 or may be a display of another computing device.

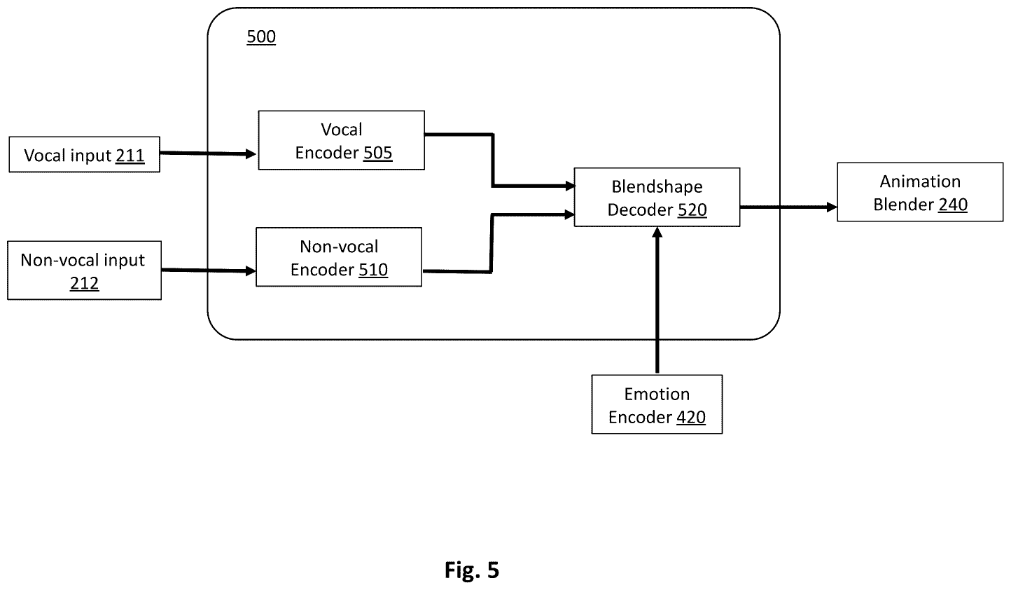

Facial expression model 225 takes as input one or more of vocal output 211, non-vocal output 212, and emotion encodings 216 to generate animation parameters for the avatar's face. FIG. 5 illustrates an example DNN architecture 500 of facial expression model 225. Vocal output 211 is provided to vocal encoder 505, which is trained (using supervised training) to output local emotion-related features from vocal input. Non-vocal output 212 is provided to non-vocal (e.g., music) encoder 510, which is trained (using supervised training) to output local emotion-related features from non-vocal input. The emotion-related feature encodings determined by vocal encoder 505 and non-vocal encoder 510 are provided to blendshape decoder 520, which is one approach to creating facial animations contemplated by this disclosure. In particular embodiments, blendshape decoder 520 also receives output from emotion encoder 420, which encodes emotion-related information from a user instruction. The emotion-related features from vocal encoder 505 and from non-vocal encoder 510 are local features (i.e., reflect emotion content from the audio input currently being played), while emotion-related features from emotion encoder 420 based on the user instruction encode global emotion-related features, i.e., features that don't immediately vary based on the current content of the audio being played. For example, a moment in a particular song may correspond to a neutral emotion, but the user's instruction may globally indicate a “happy” emotion, which would apply during the entire song. Blendshape decoder 520 combines and processes the inputs it receives and generates blendshape parameters for animating the avatar's face, and these animation parameters are provided to animation blender 240. In DNN architecture 520, blendshape decoder 520 is specifically trained (using supervised learning) for emotion-related facial animation tasks, so that after training, the parameters (e.g., model weights) of blendshape decoder 520 are specific to decoding encoded emotion-related features from vocal input, non-vocal input, and a user's natural-language instruction.

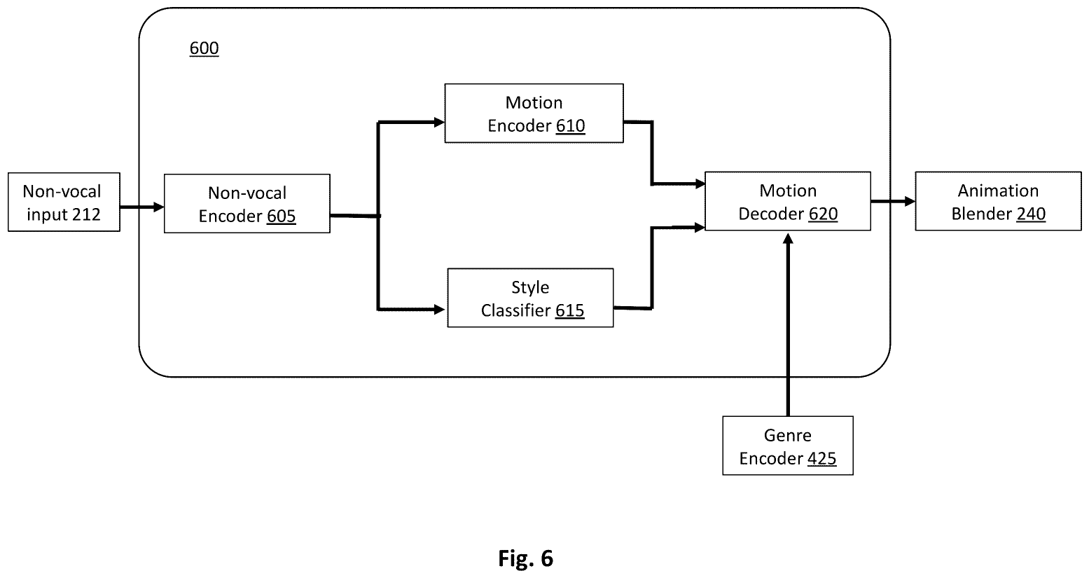

Dance model 230 takes as input one or more of non-vocal output 212 and dance encodings 217 to generate animation parameters for the avatar's body (e.g., the avatar's head, arms, legs, hand, torso, etc.). FIG. 6 illustrates an example DNN architecture 600 of dance model 230. Non-vocal input 212 (output by source separation model 210) is provided to non-vocal (e.g., music) encoder 605, which is trained specifically to encode dance-related animation features from non-vocal input. The features output by non-vocal encoder 605 are provided to motion encoder 610 and style classifier 615. Motion encoder 610 generates motion parameters based on the dance-related features that are determined from the currently playing non-vocal input. The style classifier classifies a particular music style (e.g. hip-hop, rock, jazz, classical, etc.) based on the input non-vocal features from non-vocal encoder 605. Motion decoder takes as input the encodings from motion encoder 610, the classification(s) from style classifier 615, and, in particular embodiment, the encodings from genre encoder 425. In particular embodiments, the output from motion encoder 610 and style classifier 615 define local features (i.e., features based on the audio currently being played), while output from genre encoder 425 provides global features (i.e., an overall dance-related features defined by a user instruction, which applies throughout the entire audio track). While the examples of FIGS. 4 and 6 illustrate a music genre encoder, this disclosure contemplates that genre encoder 425 is a specific implementation of a dance encoder for encoding dance-related body-motion content from the user instruction. Motion decoder 620 is trained, using supervised training, specifically for animating avatar motion using the inputs described above. During inferencing, motion decoder 620 outputs a sequence of pose parameters for body animation, which are provided to animation blender 240.

Step 140 of the example method of FIG. 1 includes rendering, in real time and temporally coincident with the audio input, the determined avatar animation. In the example of FIG. 2, animation blender 240 receives animation parameters from one or more of lip-sync model 220, facial expression model 225, and dance model 230, and then blends these animation layers so that rending module 246 can generate the final facial and whole-body animation (as applicable, for example based on a selected user animation mode) for animating avatar 244, resulting in animated avatar 250.

In particular embodiments, a user may select an avatar animation mode for animating an avatar. The selected avatar animation mode may select a particular set of the one or more trained avatar animation models for animating the avatar, and different modes may provide different views of an avatar. For example, a “singing mode” may provide a relatively zoomed-in view of an avatar's head and face, and the corresponding avatar animation models used during inferencing may be a lip-sync model and a facial expression model. As another example, a “dance mode” may provide a relatively zoomed-out view of the avatar's entire body, and the corresponding avatar animation models used during inferencing may be a dance model and a facial-expression model, although in particular embodiments, a lip-sync model may also be used in a dance mode.

During inferencing, particular embodiments buffer an audio input, such as audio input 201, and performing the inferencing task in real-time on a buffer by-buffer basis. For example, particular embodiments may buffer approximately 120 milliseconds worth of audio input 201, and perform inferencing on each 120 ms buffer, such that the avatar is animated in real-time as audio input 201 plays.

Embodiments of this disclosure provide interactive user experiences when listening to audio, such as songs for Karaoke, by providing an animated avatar that corresponds to the audio content. For example, an avatar may be a virtual alternate or partner for singing or dancing to music. In particular embodiments, the vocal output provided by a source separation model may be input to a voice-to-text model to convert the vocal output to text, which may then be displayed to the user, e.g., during a Karaoke performance of a song.

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1. Moreover, this disclosure contemplates that some or all of the computing operations described herein, including steps of the example method illustrated in FIG. 1, may be performed by circuitry of a computing device described herein, by a processor coupled to non-transitory computer readable storage media, or any suitable combination thereof.

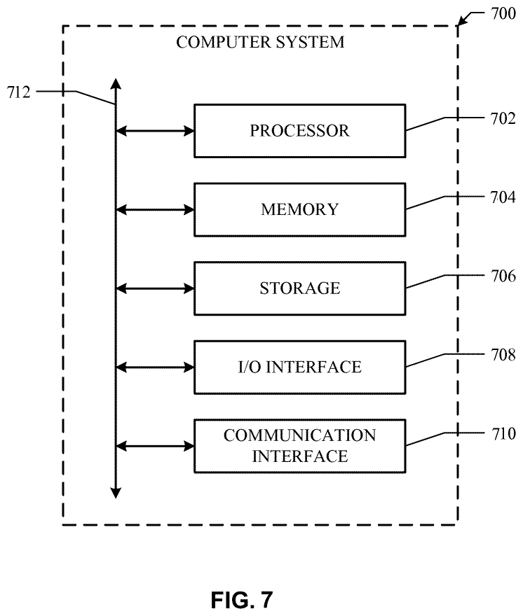

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing an audio input comprising a mixture of vocal sounds and non-vocal sounds;
separating, by a trained audio source-separation model, the audio input into a first audio output representing the vocal sounds and a second audio output representing the non-vocal sounds;
determining, by one or more trained avatar animation models and by separately encoding the first audio output representing the vocal sounds and the second audio output representing the non-vocal sounds, an avatar animation temporally corresponding to the audio input; and
rendering, in real time and temporally coincident with the audio input, the determined avatar animation.

2. The method of claim 1, wherein the trained audio source-separation model is defined by a self-supervised training process comprising:
providing, to a source-separation model, a plurality of training audio inputs;
for each of the training audio inputs:
separating, by the source-separation model, each of the plurality of training audio inputs into a first training audio output representing vocal sounds and a second training audio output representing non-vocal sounds;
encoding, by a vocal encoder, the first training audio output;
encoding, by a music encoder, the second training audio output;
constructing, by an audio decoder and based on the encoded first training audio output and the encoded second training audio output, a composite audio output;
classifying, by a sound classifier, (1) the encoded first training audio output as vocal or non-vocal sounds and (2) the encoded second training audio output as vocal or non-vocal sounds; and
updating the source separation model based on (1) a similarity between the composite audio output and the respective training audio input and (2) the classifications made by the sound classifier.

3. The method of claim 2, wherein the trained audio source separation model is further defined by a supervised learning training process comprising, for each of the plurality of training audio inputs:
providing a predetermined training avatar animation;
determining, by a pretrained instance of the one or more trained avatar animation models and from the first training audio output and the second training output, a corresponding training avatar animation output; and
updating the source separation model based on a similarity between the predetermined training avatar animation and the corresponding training avatar animation output.

4. The method of claim 1, further comprising:
accessing a natural-language input made by a user and corresponding to the audio input;
determining, based on one or more encoded features of the natural-language input and by a trained classifier, at least one animation classification for animating the avatar;
determining, based on the at least one animation classification, a subsequent encoding of the one or more encoded features; and
determining the avatar animation further based on the subsequent encoding of the one or more encoded features.

5. The method of claim 4, wherein the at least one animation classification comprises at least one of an emotion classification or a dance classification based on the one or more encoded features of the natural-language input.

6. The method of claim 5, further comprising:
when the at least one animation classification comprises an emotion classification, then determining the subsequent encoding using an emotion encoder to output one or more encoded emotion features for animating a facial expression of the avatar; and
when the at least one animation classification comprises a dance classification, then determining the subsequent encoding using a dance encoder to output or more encoded dance features for animating a body movement of the avatar.

7. The method of claim 6, wherein the one or more trained avatar animation models comprise a trained facial expression model, the method further comprising:
generating, by a trained vocal encoder of the trained facial expression model, a set of encoded vocal features;
generating, by a trained non-vocal encoder of the trained facial expression model, a set of encoded non-vocal features; and
generating, by a decoder of the trained facial expression model, a facial-expression animation for the avatar based on the set of encoded vocal features, the set of encoded non-vocal features, and the one or more encoded emotion features.

8. The method of claim 6, wherein the one or more trained avatar animation models comprise a trained dance model, the method further comprising:
generating, by a trained non-vocal encoder of the trained dance model, a set of non-vocal features;
generating, by a trained motion encoder of the trained dance model, a set of encoded motion features; and
generating, by a trained dance-style classifier of the trained dance model, a dance classification based on the encoded non-vocal features;
generating, by a motion decoder of the trained dance model, a dance animation for the avatar based on the set of encoded motion features, the dance classification, and the one or more encoded dance features.

9. The method of claim 1, wherein the one or more trained avatar animation models comprise a trained facial expression model, the method further comprising:
generating, by a trained vocal encoder of the trained facial expression model, a set of encoded vocal features;
generating, by a trained non-vocal encoder of the trained facial expression model, a set of encoded non-vocal features; and
generating, by a decoder of the trained facial expression model, a facial-expression animation for the avatar based on the set of encoded vocal features and the set of encoded non-vocal features.

10. The method of claim 1, wherein the one or more trained avatar animation models comprise a trained dance model, the method further comprising:
generating, by a trained non-vocal encoder of the trained dance model, a set of non-vocal features;
generating, by a trained motion encoder of the trained dance model, a set of encoded motion features; and
generating, by a trained dance-style classifier of the trained dance model, a dance classification based on the encoded non-vocal features;
generating, by a motion decoder of the trained dance model, a dance animation for the avatar based on the set of encoded motion features and the dance classification.

11. The method of claim 1, wherein the trained one or more animation models comprise:
a lip-sync model for animating a mouth of the avatar;
a facial-expression model for animation a face of the avatar; and
a dance model for animating a body of the avatar.

12. The method of claim 11, further comprising:
receiving a user input comprising an identification of an avatar animation mode for animating the avatar; and
selecting, based on the avatar animation mode, one or more of the trained one or more animation models for animating the avatar.

13. One or more non-transitory computer readable storage media storing instructions and coupled to one or more processors that are operable to execute the instructions to:
access an audio input comprising a mixture of vocal sounds and non-vocal sounds;
separate, by a trained audio source-separation model, the audio input into a first audio output representing the vocal sounds and a second audio output representing the non-vocal sounds;
determine, by one or more trained avatar animation models and by separately encoding the first audio output representing the vocal sounds and the second audio output representing the non-vocal sounds, an avatar animation temporally corresponding to the audio input; and
render, in real time and temporally coincident with the audio input, the determined avatar animation.

14. The media of claim 13, wherein the trained audio source-separation model is defined by a self-supervised training process comprising:
providing, to a source-separation model, a plurality of training audio inputs;
for each of the training audio inputs:
separating, by the source-separation model, each of the plurality of training audio inputs into a first training audio output representing vocal sounds and a second training audio output representing non-vocal sounds;
encoding, by a vocal encoder, the first training audio output;
encoding, by a music encoder, the second training audio output;
constructing, by an audio decoder and based on the encoded first training audio output and the encoded second training audio output, a composite audio output;
classifying, by a sound classifier, (1) the encoded first training audio output as vocal or non-vocal sounds and (2) the encoded second training audio output as vocal or non-vocal sounds; and
updating the source separation model based on (1) a similarity between the composite audio output and the respective training audio input and (2) the classifications made by the sound classifier.

15. The media of claim 13, further coupled to one or more processors that are operable to execute the instructions to:
access a natural-language input made by a user and corresponding to the audio input;
determine, based on one or more encoded features of the natural-language input and by a trained classifier, at least one animation classification for animating the avatar;
determine, based on the at least one animation classification, a subsequent encoding of the one or more encoded features; and
determine the avatar animation further based on the subsequent encoding of the one or more encoded features.

16. The media of claim 13, wherein the trained one or more animation models comprise:
a lip-sync model for animating a mouth of the avatar;
a facial-expression model for animation a face of the avatar; and
a dance model for animating a body of the avatar.

17. An apparatus comprising: one or more non-transitory computer readable storage media storing instructions; and one or more processors coupled to the non-transitory computer readable storage media, the one or more processors operable to execute the instructions to:
access an audio input comprising a mixture of vocal sounds and non-vocal sounds;
separate, by a trained audio source-separation model, the audio input into a first audio output representing the vocal sounds and a second audio output representing the non-vocal sounds;
determine, by one or more trained avatar animation models and by separately encoding the first audio output representing the vocal sounds and the second audio output representing the non-vocal sounds, an avatar animation temporally corresponding to the audio input; and
render, in real time and temporally coincident with the audio input, the determined avatar animation.

18. The apparatus of claim 17, wherein the trained audio source-separation model is defined by a self-supervised training process comprising:
providing, to a source-separation model, a plurality of training audio inputs;
for each of the training audio inputs:
separating, by the source-separation model, each of the plurality of training audio inputs into a first training audio output representing vocal sounds and a second training audio output representing non-vocal sounds;
encoding, by a vocal encoder, the first training audio output;
encoding, by a music encoder, the second training audio output;
constructing, by an audio decoder and based on the encoded first training audio output and the encoded second training audio output, a composite audio output;
classifying, by a sound classifier, (1) the encoded first training audio output as vocal or non-vocal sounds and (2) the encoded second training audio output as vocal or non-vocal sounds; and
updating the source separation model based on (1) a similarity between the composite audio output and the respective training audio input and (2) the classifications made by the sound classifier.

19. The apparatus of claim 17, wherein the one or more processors are further operable to execute the instructions to:
access a natural-language input made by a user and corresponding to the audio input;
determine, based on one or more encoded features of the natural-language input and by a trained classifier, at least one animation classification for animating the avatar;
determine, based on the at least one animation classification, a subsequent encoding of the one or more encoded features; and
determine the avatar animation further based on the subsequent encoding of the one or more encoded features.

20. The apparatus of claim 17, wherein the trained one or more animation models comprise:
a lip-sync model for animating a mouth of the avatar;
a facial-expression model for animation a face of the avatar; and
a dance model for animating a body of the avatar.
